(19) United States
(12) Patent Application Publication
(10) Pub. No.: US 2005/0138771 A1
(43) Pub. Date: Jun. 30, 2005

(54) Hinge

(76) Inventor: Ding-Hone Su, Taipei Hsien (TW)

Correspondence Address: BIRCH STEWART KOLASCH & BIRCH, PO BOX 747, FALLS CHURCH, VA, 22040-0747, US

(21) Appl. No.: 10/747,194

(22) Filed: Dec. 30, 2003

(51) Int. Cl. E05D 11/10

(52) U.S. Cl. 16/330

(57) ABSTRACT

A hinge mounted between a joint of two articles is provided. The hinge comprises a sleeve fixed to one article, the sleeve including internal slots, a cam follower including external ridges to fit in the slots so that turning the cam follower will move the ridges either downward to a steady position or upward to a non-steady position along the slots, the cam engages with the cam follower so that the cam adapts to turn either to a first position or a second position with respect to the sleeve, a spring in the sleeve to maintain the cam and cam follower in the steady position, and a shaft having one end fixed to the cam to turn together. The invention is particularly applicable to cellular phones.

### FIELD OF THE INVENTION

The present invention relates to hinges and more particularly to a hinge for a cellular phone that reduces rotational wear via implementation of cam mechanism acting on a sleeve and a cam follower of the hinge.

### BACKGROUND OF THE INVENTION

Cellular phones are advantageous for being compact and portable. Typically, a person places a cellular phone in his/her pocket, handbag, briefcase, or the like whilst on the move. However, it is often that a person inadvertently presses the keys of the cellular phone since they are provided on a front surface of the phone body. Some cellular phone manufacturers have developed key lock mechanisms for the prevention of inadvertent key pressing. However, a cellular phone having such a key lock mechanism is inconvenient.

A solution to the above problem is to incorporate a flap cover hinged to the body of a cellular phone. A great number of different hinges have been developed. For example, U.S. Pat. No. 5,697,124 discloses a hinge mechanism for foldable electronic apparatus in which a hinge housing including internal components (e.g., hinge shaft, cam follower, hinge arm, coil spring, and hinge cover) are provided. Guide slit and hooking grooves, formed on the hinge housing, are adapted to cooperate to control the rotational angle of the cam follower about the hinge shaft to open or close a flip-cover. It is difficult to manufacture guide slit and grooves on the hinge housing. Also, the hinge housing is relatively large and the hinge housing has a thicker surface for maintaining its structural integrity. Another prior art U.S. Pat. No. 5,724,683 discloses a hinge mechanism for supporting the seat of the seat lid of a toilet bowl in which the shaft, hinge pin, cam mechanism, and spring are provided in a cylindrical case. Also, components including pads, screws, and O-ring are provided. The hinge pin has a means to rotate with the shaft. Further, the cam includes a slider mounted on the shaft in the case so as to turn together with the shaft. It is disadvantageous for being structurally complex. Also, such hinge mechanism is required to install in a pair when incorporated in a cellular phone. As a result, a reduction in size is made impossible. Still another prior art U.S. Pat. No. 5,937,062 discloses a hinge module for mounting a flip onto a portable telephone set in which a first cam, a second cam, a guiding member, an elastic member, and a retractable member are provided for controlling the opening or closing of a flip. It is advantageous for the reduction of the hinge module. However, there is no housing provided as protection. As such, it is difficult to position and assemble. Also, it is not structurally robust and has a shortened period of use.

Thus, it is desirable to provide a hinge having a reduced number of components while maintaining its structural integrity in order to overcome the above drawbacks such as complex construction and poor strength of the prior art.

### SUMMARY OF THE INVENTION

It is an object of the present invention to provide a hinge for cellular phone that reduces rotational wear and increases operating stability. This can be attained by implementing a sleeve having a plurality of slots and a cam follower having a plurality of interdental ridges to engage with the slots.

To achieve the above and other objectives, the present invention provides a hinge mounted in a joint on the flap cover and the body of a cellular phone. The hinge comprising a sleeve fixed to the body, the sleeve including a plurality of longitudinal slots on an internal wall; a cam follower including a plurality of longitudinal ridges on an outer surface corresponding to the slots so that turning the cam follower will move the ridges either downward to a steady position or upward to a non-steady position along the slots. Having a cam means fixing the flap cover, the cam means including a bottom cavity and two cam members at opposite sides of the cavity wherein the cavity and the cam members are adapted to engage with the raised members and the recess respectively so that the cam adapts to turn either to an first position or a second position with respect to the sleeve; a spring in the sleeve, the spring having one end pressed against the bottom of the sleeve and the other end against the cam follower so to maintain the cam and the cam follower in the steady position; and a shaft having one end fixed to the cam means so as to turn either from the first position to the second position or from the second position or the first position with the cam follower being moved either downward to a steady position or upward to a non-steady position with respect to the sleeve, and the other end passing through the cam follower and spring to control the movement of the cam follower.

The above and other objects, features and advantages of the present invention will become apparent from the following detailed description provided with the accompanying drawings.

### BRIEF DESCRIPTION OF THE DRAWINGS

FIG. 1 is a perspective view of a preferred embodiment of a hinge according to the present invention;

FIG. 2 is an exploded view of the present invention;

FIGS. 3A and 3B are cross-sectional views of closing and opening operation of the hinge respectively for the illustration of one article incorporating the hinge pivoting about the other coupled article; and

FIG. 4 illustrates a hypothetical view of the hinge mounted in a joint of a flap cover and a body of a cellular phone.

### DETAILED DESCRIPTION OF THE PREFERRED EMBODIMENTS

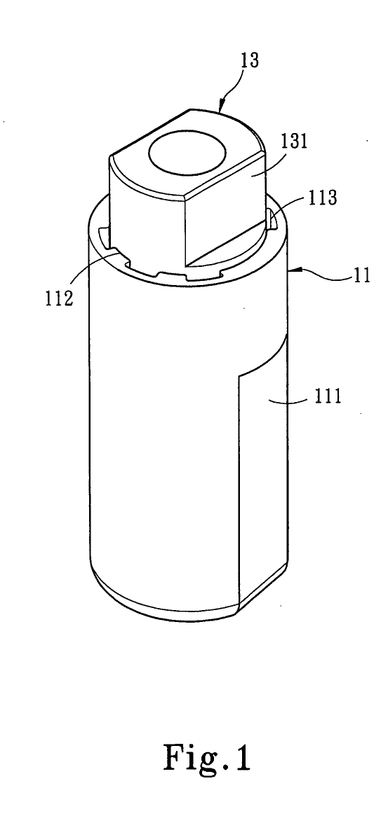

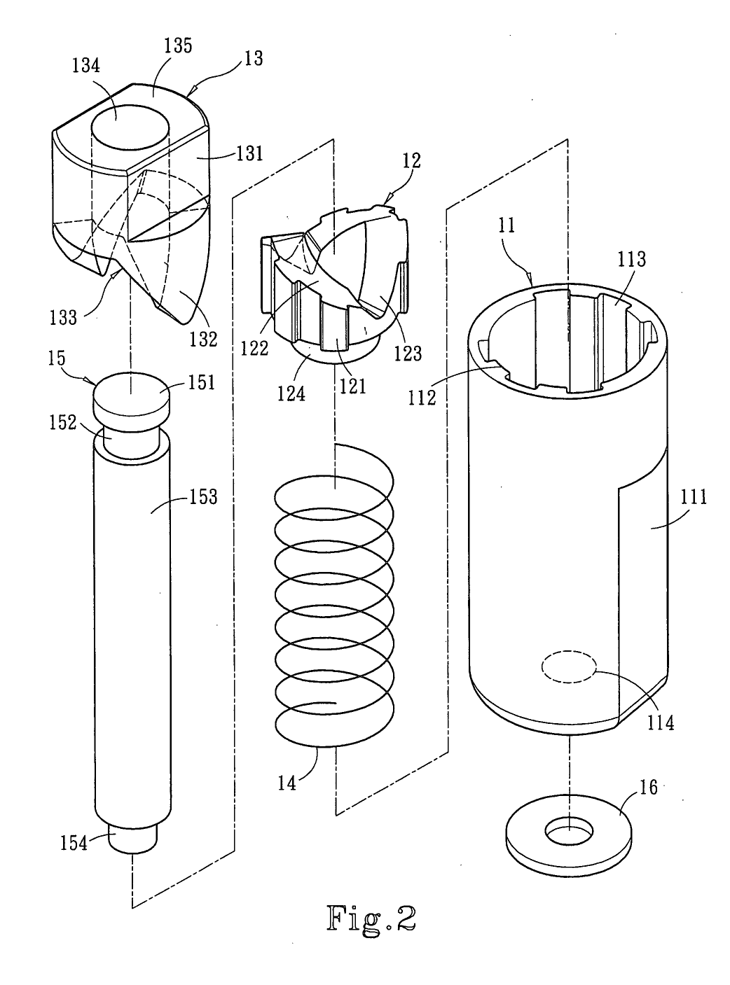

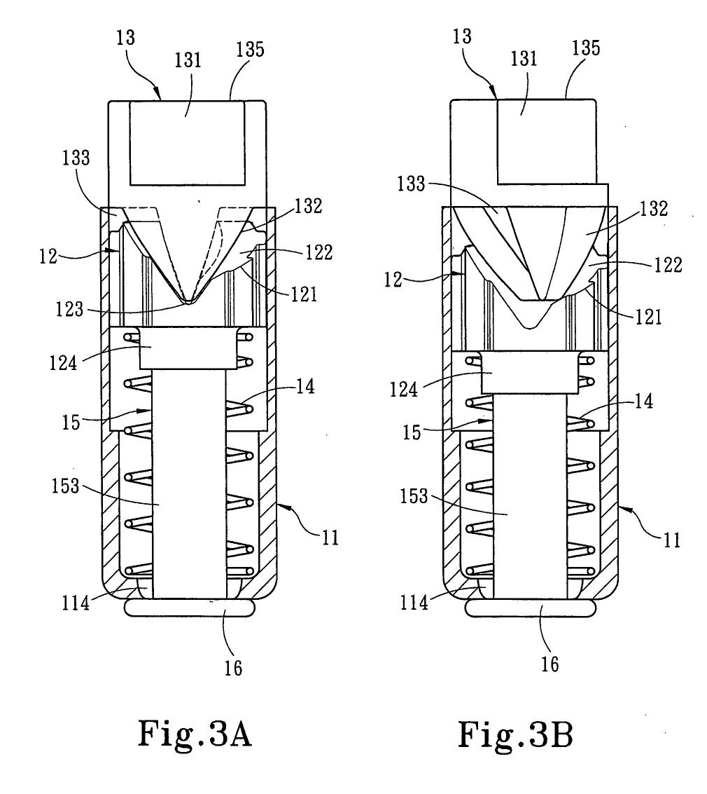

Referring to FIGS. 1 and 2, there is shown a hinge constructed in accordance with the invention. The hinge comprises a sleeve 11 including two opposite rectangular flats 111 on the circumferential surface, the flats 111 being adapted to fasten at a joint of two articles as detailed later, a plurality of longitudinal slots 113 on an internal wall, a first opening 112 at one end, and a second opening 114 at the other end, the second opening 114 having a diameter much smaller than that of the first opening 112; and a cam follower 12 including a recess 123 at one end, a hollow cylindrical protrusion 124 at the other end, two raised members 122 at opposite sides of the recess 123, and a plurality of longitudinal ridges 121 on the outer surfaces of the raised members 122, the ridges 121 fitting in the slots 113. Turning the cam follower 12 causes the ridges 121 to move downward to a steady position or upward to a non-steady position along the slots 113 (indicated by dash line of FIG. 3A). That is, the cam follower 12 has a steady position and a non-steady position with respect to the sleeve 11 as described in detail later.

The hinge further comprises a cam device 13 including two opposite rectangular flats 131 on the outer surface, the flats 131 being adapted to fasten at a joint of two articles as detailed later, a flat top surface 135, a longitudinal cylindrical bore 134 open at both ends, a bottom cavity 133, and two cam members 132 at opposite sides of the cavity 133. The cavity 133 and the cam members 132 are adapted to engage with the raised members 122 and the recess 123 respectively. The cam device 13 has a diameter slightly smaller than that of the first opening 112 so as to fit in the sleeve 11. As indicated by the dashed line, the cam device 13 is adapted to dispose in either the first or second positions with respect to the sleeve 11 by turning. Also, the turning force of the cam device 13 will exerts evenly onto the ridges 121 and the mated slots 113. As a result, the cam device 13 is neither subject to excessive wear nor deformity.

The hinge further comprises a helical spring 14 having one end pressed against the second opening 114 and the other end put on the protrusion 124 as the helical spring 14 mounted in the sleeve 11 (as indicated by the dashed line). The provision of the helical spring 14 aims at maintaining both the cam device 13 and the cam follower 12 in the steady position. The hinge further comprises a shaft 15 formed of metal. The shaft 15 comprises a circular top member 151, a neck 152 engaged with edges of the bore 134, a main shank 153, and a cylindrical bottom projection 154 having a diameter smaller than that of the shank 153. The shaft 15 is passed through the helical spring 14, the cam follower 12, and the cam device 13 and has its top member 151 flush with the top surface 135 and bottom projection 154 coming from the second opening 114 to tightly couple with a washer 16. The cam follower 12 and cam device 13 together with the helical spring 14 and shaft 15 are mounted in the sleeve 11 so that the hinge can be operated by turning the cam device 13 and thus the cam follower 12 as detailed later.

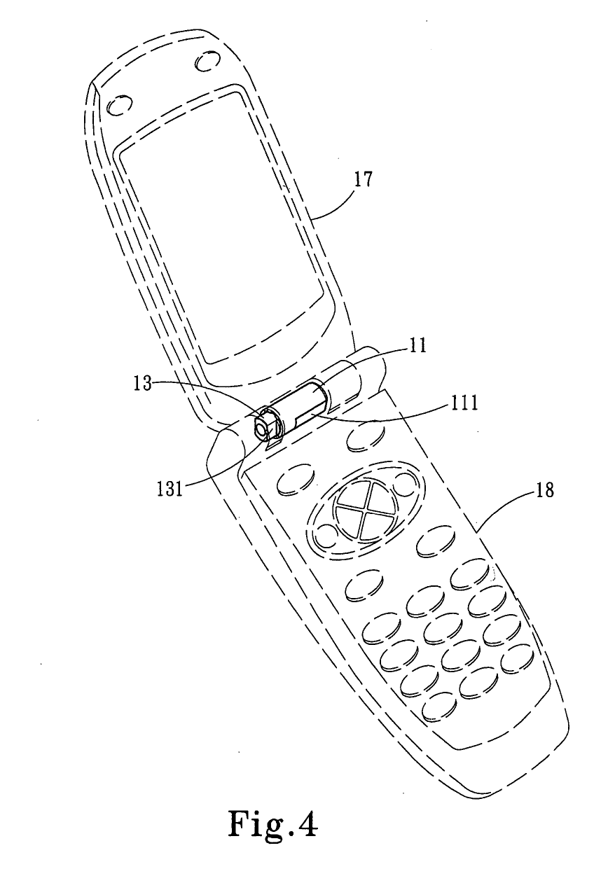

Referring to FIGS. 3A, 3B, and 4, operations of the invention for opening and closing a flap cover 17 with respect to a body 18 of a cellular phone will now be described in detail below. In a first position, the flap cover 17 is closed onto the body 18 with both the cam device 13 and the cam follower 12 held in place (see FIG. 3A). Turning the cam device 13 (i.e., turning the cam members 132 and the cavity 133) with respect to the cam follower 12 (i.e., the recess 123 and the raised members 122) will cause both the cam device 13 and cam follower 12 to move to a second position (see FIG. 3B). That is, the flap cover 17 is pivoted to form an angle with respect to the body 18 in an opened state.

Referring to FIG. 4 again, in an exemplary example of the invention the hinge is mounted in a joint of the flap cover 17 and the body 18 of a cellular phone. As shown, the flats 111 of the sleeve 11 are fixed to the body 18 and the flats 131 of the cam device 13 are fixed to the flap cover 17 respectively. Hence, a user can either open the flap cover 17 (i.e., in the second position) or close the flap cover 17 (i.e., in the first position) with respect to the body 18.

While the invention herein disclosed has been described by means of specific embodiments, numerous modifications and variations could be made thereto by those skilled in the art without departing from the scope and spirit of the invention. Accordingly, the appended claims are intended to cover all of the aforementioned.

1. A hinge mounted in a joint of two articles, comprising:
a sleeve fixed to one article, said sleeve including a plurality of longitudinal slots on an internal wall;
a cam follower including a plurality of longitudinal ridges on an outer surfaces fitted to said slots so that turning said cam follower will move said ridges either downward to a steady position or upward to a non-steady position along said slots;
a cam device means fixed to said other article, said cam follower means including a bottom cavity and two cam follower members at opposite sides of said cavity wherein said cavity and said cam follower members are adapted to engage with said raised members and said recess respectively so that said cam device means is adapted to turn to either a first position or a second position with respect to said sleeve;
a spring in said sleeve, said spring having one end against said bottom of said sleeve and said other end against said cam follower to maintain said cam means and cam follower in said steady position; and
a shaft having one end fixed to said cam means to turn either from said first position to said second position or from said second position or said first position with said cam follower being moved either downward to a steady position or upward to a non-steady position with respect to said sleeve, with said other end passing through said cam follower and said spring so as to control said movement of said cam follower.

2. The hinge according to claim 1, wherein said sleeve further comprises a washer on said underside, said washer being secured to said other end of said shaft.
